(19) United States
(12) Patent Application Publication
(10) Pub. No.: US 2026/0339006 A1
(43) Pub. Date: Oct. 29, 2026

(54) DISPLAY MEDIUM, PROCESSING DEVICE, PROGRAM, AND RECORDING MEDIUM

(71) Applicant: DWANGO CO., LTD., Chuo-ku, Tokyo (JP)

(72) Inventor: Kaisei SAKURAI, Chuo-ku (JP)

(73) Assignee: DWANGO CO., LTD., Chuo-ku, Tokyo (JP)

(21) Appl. No.: 19/110,179

(22) PCT Filed: Nov. 15, 2023
(86) PCT No.: PCT/JP2023/041010

§ 371 Date: Mar. 10, 2025

(30) Foreign Application Priority Data
Dec. 28, 2022 (JP) 2022-212402

(51) Int. Cl. G02B 5/20

(52) U.S. Cl. CPC G02B 5/201

(57) ABSTRACT

A display medium includes: a first layer having a blue region in each of a plurality of cells; and a second layer having a red region and a green region in each of the plurality of cells. When viewed in a prescribed direction, each of the red region and the green region in a second cell abuts on the blue region of a first cell in the prescribed direction. The display medium displays first content using the red region, the green region, and the blue region at a first perspective located in the prescribed direction; displays second content using the red region at a second perspective located in a direction in which the green region and the blue region overlap; and displays third contents using the green region at a third perspective located in a direction in which the red region and the blue region overlap.

### FIELD

The present disclosure relates to a display medium, a processing device, a program, and a recording medium.

### BACKGROUND

Human beings are capable of perceiving colors by a long wave sensitive cone, a middle wave sensitive cone, and a short wave sensitive cone, which are three cells perceiving colors. On the other hand, in a case where any of the cones has a dysfunction or does not function, minority color vision may occur. In general, a minority color vision carrier has a problem with the perception of colors of red or/and green. For example, in a case where there are green letters on a red background, or in a case where there are red letters on a green background, the minority color vision carrier may not be capable of perceiving the letters at all.

In consideration of such circumstances, universal design, which is designed by using colors that are easily viewable regardless of whether a person has minority color vision, is in widespread use. In the universal design, there are several indices such as not using red and green that are imperceptible for the minority color vision carrier.

In addition, a display medium displaying contents different from each other in a plurality of directions is known (refer to PTLs 1 to 3).

### PATENT LITERATURE

PTL 1: JP6374625B

PTL 2: JP6758447B

PTL 3: JP6764990B

### SUMMARY

However, in the universal design, available colors are limited, and thus, it is difficult to express the content with an arbitrary color.

In a case where the content is expressed with the arbitrary color, the content is imperceptible for the minority color vision carrier, and thus, it is also considered to display a content expressed with an arbitrary color for an able-bodied individual, and a content expressed with a color suitable for a minority color vision carrier together. However, in order to display the contents with the same details together by changing color variation, a large space is required.

The disclosure has been made in consideration of the circumstances described above, and an object of the disclosure is to provide a technology capable of displaying a content that is easily viewable for both of an able-bodied individual and a minority color vision carrier while saving a space.

A display medium of one aspect of the disclosure relates to a display medium displaying a content visible to an able-bodied individual and a minority color vision carrier. The display medium includes a first layer that is formed of a transparent member, has a plurality of cells, and has a blue region in each of the plurality of cells, and a second layer that is formed of a transparent member, has a plurality of cells, and has a red region and a green region in each of the plurality of cells, in which when an overlapping state of a first cell of the first layer and a second cell of the second layer corresponding to the first cell of the first layer is viewed in a predetermined direction, each of the red region and the green region of the second cell is disposed so as to abut on the blue region of the first cell in the predetermined direction. The display medium displays a first content using the red region, the green region, and the blue region at a first perspective located in the predetermined direction, displays a second content using the red region at a second perspective located in a direction in which the green region and the blue region overlap each other, and displays a third content using the green region at a third perspective located in a direction in which the red region and the blue region overlap each other.

A processing device of one aspect of the disclosure relates to a processing device allocating a color to each pixel of the first cell of the display medium and the cells of the second layer. Each of the blue region of the first cell, the red region of the second cell, and the green region of the second cell includes a plurality of pixels, and the processing device includes a calculation unit calculating each value of red, green, and blue of colors displayed in the first cell and the second cell in the first content, and an allocation unit allocating red, green, or blue to pixels corresponding in number to each of the calculated values of red, green, and blue, and allocating black to the other pixels, in the plurality of pixels of each of the regions.

One aspect of the disclosure is a program for causing a computer to function as the processing device described above.

According to the disclosure, it is possible to provide the technology capable of displaying the content that is easily viewable for both of the able-bodied individual and the minority color vision carrier while saving the space.

### BRIEF DESCRIPTION OF DRAWINGS

FIG. 1 is a side view of a display medium according to a first embodiment.

FIG. 2 is a perspective view of the display medium according to the first embodiment.

FIG. 3 is a side view of a cell according to the first embodiment.

FIG. 4 is a (first) top view of a color region of a pair of cells according to the first embodiment.

FIG. 5 is a (second) top view of the color region of the pair of cells according to the first embodiment.

FIG. 6 is a diagram illustrating a function block of a processing device generating output data for producing the display medium according to the first embodiment.

FIG. 7 is a flowchart illustrating processing of determining a color to be allocated to the display medium according to the first embodiment.

FIG. 8 is a side view of a cell according to a second embodiment.

FIG. 9 is a top view of a color region of a pair of cells according to the second embodiment.

FIG. 10 is a flowchart illustrating processing of determining a color to be allocated to a display medium according to the second embodiment.

FIG. 11 is a perspective view of a display medium according to a third embodiment.

FIG. 12 is a diagram illustrating an example of a cell of the display medium according to the third embodiment.

FIG. 13 is a diagram illustrating an example of a shielded pixel and an exposed pixel in the display medium according to the third embodiment.

FIG. 14 is a diagram illustrating a function block of a processing device generating output data for producing the display medium according to the third embodiment.

FIG. 15 is a perspective view of a display medium according to a fourth embodiment.

FIG. 16(a) is a front view of a partition used for the display medium according to the fourth embodiment, and FIG. 16(b) is a right-side view.

FIG. 17 is a cross-sectional view of the partition used for the display medium according to the fourth embodiment.

FIG. 18 is a diagram illustrating a hardware configuration of a computer used for a processing device.

### DETAILED DESCRIPTION

Hereinafter, embodiments of the disclosure will be described with reference to the drawings. In the description of the drawings, the same reference numerals will be applied to the same parts, and the description will be omitted.

### Display Medium

A display medium according to an embodiment of the disclosure displays a content visible to an able-bodied individual and a minority color vision carrier. The display medium displays a content easily viewable for an able-bodied individual and a minority color vision carrier in directions different from each other.

The minority color vision carrier is a person who views or perceives colors differently from most other normal people, and may be medically referred to as color blindness, color weakness, or color vision defective. Most people have three types of cones to perceive colors. The minority color vision carrier has a dysfunction in one specific cone or a plurality of cones among the three types of cones, and thus, has color vision different from that of most other people.

The content displayed by the display medium according to the embodiment of the disclosure is expressed with colors applied to each of a plurality of pixels on the display medium.

A first content that can be expressed with three primary colors of red, green, and blue (RGB) is displayed using pixels viewed from a first perspective among the plurality of pixels. A second content obtained by extracting a red component from the first content is displayed using pixels viewed from a second perspective among the plurality of pixels. A third content obtained by extracting a green component of the first content is displayed using pixels viewed from a third perspective among the plurality of pixels.

The able-bodied individual views the first content. Further, by the minority color vision carrier with a middle wave sensitive cone dysfunction or a long wave sensitive cone dysfunction changing the perspective and repeatedly viewing each of the second content and the third content, the display medium according to the embodiment of the disclosure enables not only the able-bodied individual but also the minority color vision carrier to view the composition of the content.

A processing device used to produce the display medium according to the embodiment of the disclosure designates colors to be applied to each pixel of the display medium, as output data input to a production apparatus for producing the display medium such as a printer.

Here, the display medium according to the embodiment of the disclosure includes a plurality of cells, and each of the cells includes a plurality of pixels.

The processing device includes a calculation unit and an allocation unit.

The calculation unit, in the first content that can be expressed with three primary colors of red, green, and blue, calculates each value of red, green, and blue of colors displayed in a predetermined cell.

The allocation unit allocates a color to each pixel in the predetermined cell such that a color of each value of red, green, and blue is displayed using the pixels viewed from the first perspective in the predetermined cell, a color of the value of red is displayed using the pixels viewed from the second perspective in the predetermined cell, and a color of the value of green is displayed using the pixels viewed from the third perspective in the predetermined cell.

The present inventors have found that the minority color vision carrier has a problem with color perception, but is capable of grasping the composition of the content and understanding the content by viewing a plurality of contents with different color variations. In addition, it has been found that there are a plurality of types of minority color vision, but most minority color vision carriers are capable of grasping the composition of the content by displaying a red-based content and a green-based content.

Therefore, the display medium is capable of displaying three different contents in three directions, and thus, displays a content that is easily viewable for the able-bodied individual in one direction, and displays the red-based content and the green-based content of which the composition can be grasped by the minority color vision carrier in the other two directions. The content that is easily viewable for the able-bodied individual is a content formed of RGB. The red-based content is a content in which the red component is extracted from the content formed of RGB, which is expressed with the contrasting density of the red color. The green-based content is a content in which green component is extracted from the content formed of RGB, which is expressed with the contrasting density of the green color. Note that the red-based content or the green-based content may not be red or green of the three primary colors, and a hue, intensity, saturation, or the like may be changed.

The minority color vision carrier repeatedly views the red-based content and the green-based content in order by switching a direction for viewing the display medium or switching the direction of the display medium, and thus, is capable of grasping the composition of the content, specifically, a portion in which the contrasting density is switched from the contrasting density of red or the contrasting density or green.

Such a display medium is capable of displaying the content that is easily viewable for both of the able-bodied individual and the minority color vision carrier while saving a space.

In addition, each of the red-based content and the green-based content displayed by the display medium is generated by extracting each color component from the content formed of RGB, and thus, the composition of the content appears in the same location of the display medium. By switching the direction for viewing the display medium or by switching the direction of the display medium, it is possible to view the contrasting density of red or the contrasting density of green at the same location, and it is possible to grasp the composition of the content with a residual image of the contrasting density of red or a residual image of the contrasting density of green.

In addition, a specific example of the display medium displaying the content that is easily viewable for both of the able-bodied individual and the minority color vision carrier while saving the space, described in the embodiment of the disclosure, will be described in a first embodiment to a fourth embodiment. Here, the display medium will be described in four embodiments, but is not limited thereto. In the display medium capable of displaying different contents in different directions, the content formed of red, green, and blue (RGB), which is easily viewable for the able-bodied individual, the red-based content generated from the component of red (R), and the green-based content generated from the component of green (G) may be displayed.

### First Embodiment

A display medium 1 according to a first embodiment will be described. The display medium 1 according to the first embodiment has the configuration of the display medium described in PTL 2.

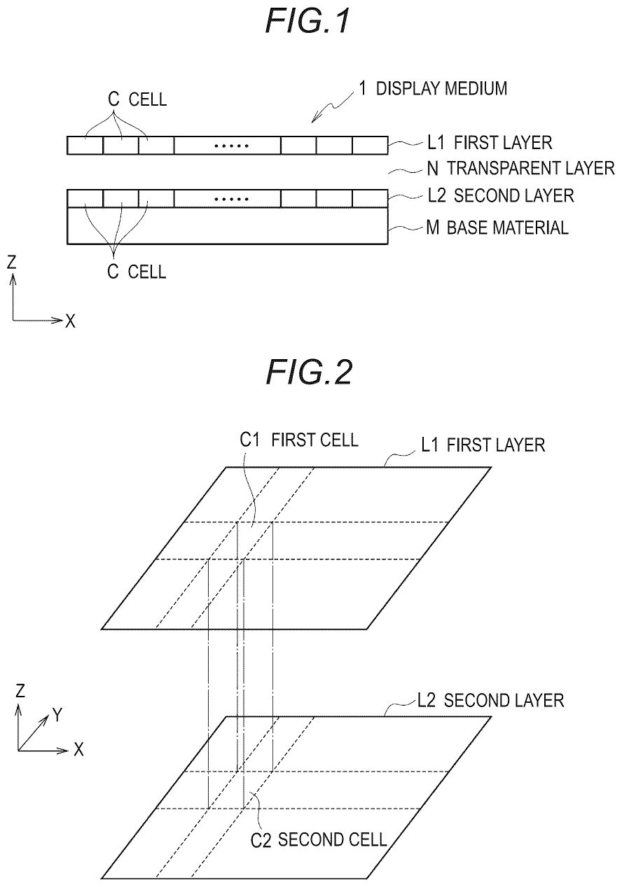

The display medium 1, as illustrated in FIG. 1, has a first layer L1 and a second layer L2. As illustrated in FIG. 1 and FIG. 2, the first layer L1 and the second layer L2 are formed in an XY plane, and are arranged in parallel to a Z-axis direction. The display medium 1 displays a plurality of contents corresponding to a plurality of directions, on the basis of a portion in which each ray of light in the plurality of directions passes through the first layer L1 and the second layer L2. Each of the contents is viewed at each perspective provided at a location on which light in the plurality of directions passing through the first layer L1 and the second layer L2 is incident. The display medium 1 displays the plurality of contents by changing the combination of the color of the portion in which light incident on the perspective passes through the first layer L1 and the color of the portion in which light passes through the second layer L2 in accordance with the direction of the light. The display medium 1 displays the content at three different perspectives above the first layer L1 and the second layer L2 in an X-axis direction.

In the first embodiment, the perspective for viewing each of the plurality of contents is provided above the first layer L1 and the second layer L2 in the Z-axis direction. By shifting the perspective in the X-axis direction, a user is capable of sequentially viewing the plurality of contents.

In the first embodiment, light in the predetermined direction, which is used when displaying the content, is emitted at least from a direction facing the perspective to the first layer L1 and the second layer L2. In a case where the perspective is provided above the first layer L1 and the second layer L2 in the Z-axis direction, light may be emitted from below the first layer L1 and the second layer L2 in the Z-axis direction, and the location of a light source is not limited. Light directed from below to above the second layer L2 in the Z-axis direction may be, for example, light from the light source provided in an arbitrary location reflected on a base material M, or may be light from the light source provided in the base material M.

As illustrated in FIG. 1, a transparent layer N is formed between the first layer L1 and the second layer L2. In addition, the base material M is provided on the second layer L2 in a direction opposite to the transparent layer N in the Z-axis direction. In the Z-axis direction, the base material M, the second layer L2, the transparent layer N, and the first layer L1 are stacked in this order, and the display medium 1 is formed.

It is preferable that the transparent layer N is formed of a material that transmits more light without absorbing the color component of the light. The transparent layer N, for example, is formed of a transparent material such as water and transparent plastic. The transparent layer N may be formed of the air. In other words, the first layer L1 and the second layer L2 may be arranged in parallel with a predetermined distance. The base material M is mirror, a blank sheet, or the like, and is formed of a member that makes colors applied to the first layer L1 and the second layer L2 easily viewable.

As illustrated in FIG. 1 and FIG. 2, each of the first layer L1 and the second layer L2 is formed of a transparent member, and has a plurality of cells C. For the location of the cell C, a printer or the like that applies a color to a color region of the cell C may be specified in accordance with the definition of the location of the predetermined cell, and the location of the cell C may not be viewed. For example, there is no compartment such as a definite line, division, or indent between the adjacent cells C, and the cell C may not be physically comparted. In addition, in the boundary between two adjacent cells C, the cell C may not be viewable by applying the same color or the same achromic color to each end portion of the two cells.

In the first embodiment, each of the cells C of the first layer L1 and each of the cells C of the second layer L2 are formed by similarly dividing each layer. Each of the cells C of the first layer L1 is formed at a location shifted from each of the cells C of the second layer L2 in the Z-axis direction. More specifically, as illustrated in FIG. 2, in the embodiment of the present invention, a first cell C1 of the first layer L1 is formed at a location shifted from a second cell C2 of the second layer L2 in the Z-axis direction. The same applies to the other cells. In the first embodiment, as with the first cell C1 and the second cell C2, a relationship between the cells formed at a location shifted in the Z-axis direction will be referred to as “corresponding”.

As illustrated in FIG. 1 to FIG. 3, the first layer L1 is formed of the transparent member, has the plurality of cells C, and has a blue region B in each of the plurality of cells C. The second layer L2 is formed of the transparent member, has the plurality of cells C, and has a red region R and a green region G in each of the plurality of cells C. In the first embodiment, a case where the blue region B, the red region R, and the green region G have the same shape will be described.

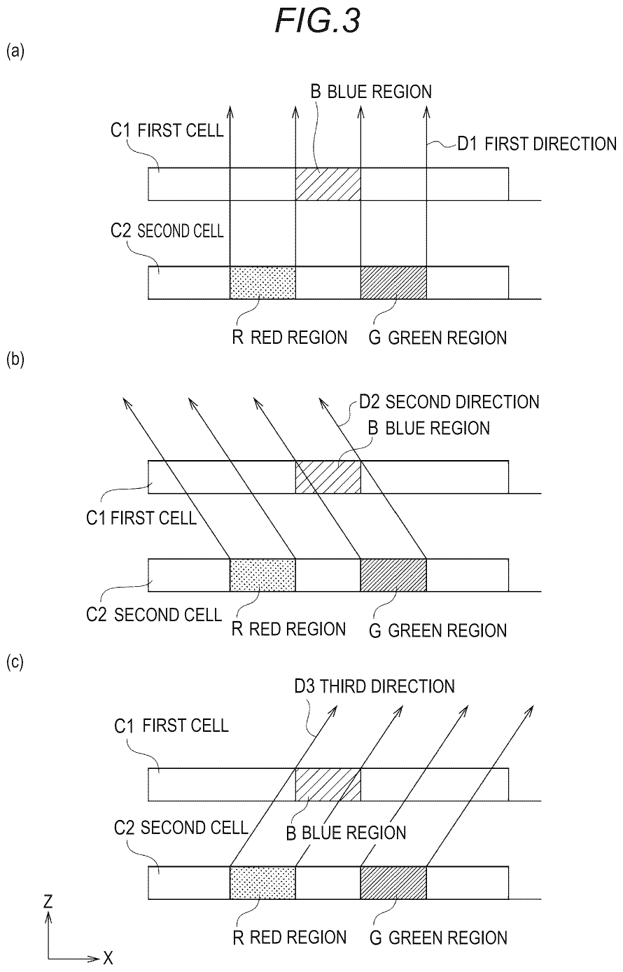

A pair of corresponding cells C will be described with reference to FIG. 3. In the first embodiment, a transparent region is provided in a boundary portion of each of the first cell C1 and the second cell C2, and a color region is provided inside the transparent region. By providing the transparent region, light passing through the color region does not to pass through the color regions of the adjacent cells, and thus, a burden on the calculation of colors that are allocated to each pixel is reduced. The color region is formed by applying an ink to each layer. The ink may be a dye ink, or may be a pigment ink. Note that in FIG. 3, a portion that is not hatched is a transparent portion to which an ink is not applied.

The location of the first cell C1 and the second cell C2 is set such that light passing through the color region of the first cell C1 passes through the second cell C2, and light passing through the color region of the second cell C2 passes through the first cell C1. In the first embodiment, a case where the pair of corresponding cells C are shifted in the Z-axis direction has been described, but the invention is not limited thereto. The pair of corresponding cells C may be shifted in an oblique direction, specifically may be shifted not only in the Z-axis direction but also in the X-axis direction.

In the first embodiment, when the overlapping state of the first cell C1 of the first layer L1 and the second cell C2 of the second layer L2 corresponding to the first cell C1 of the first layer L1 is viewed in a predetermined direction, each of the red region R and the green region G of the second cell C2 is disposed so as to abut on the blue region B of the first cell C1 in the predetermined direction.

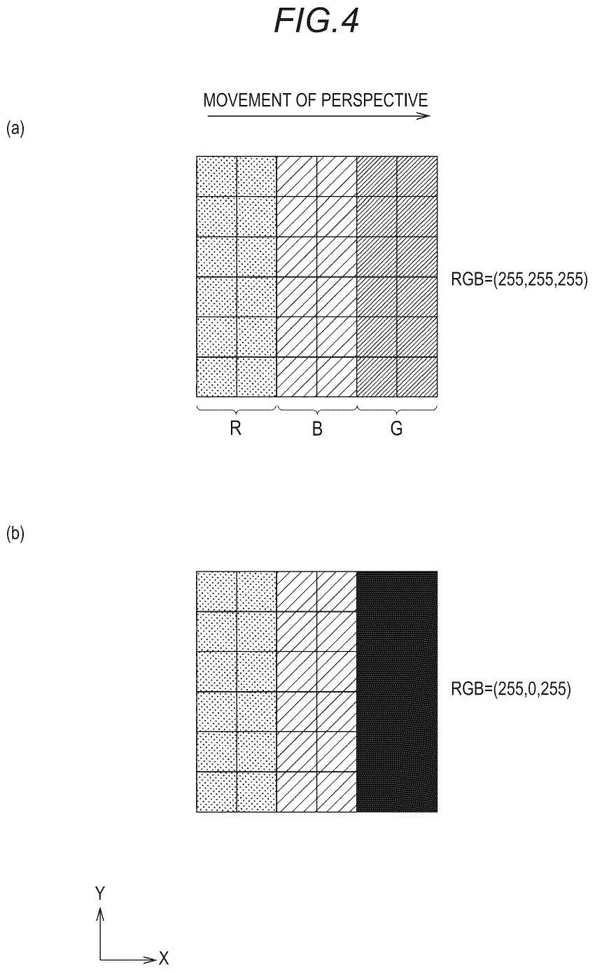

The first cell C1 of the first layer L1 has the blue region B in the center. The second cell C2 of the second layer L2 has the red region R and the green region G on either the right or the left of a region corresponding to the blue region B. In a case where the overlapping state of the first cell C1 of the first layer L1 and the second cell C2 of the second layer L2 is checked from directly above (above in the Z-axis direction), as illustrated in FIG. 4(a), the red region R, the blue region B, and the green region G are disposed in parallel from the left. The right end of the red region R and the left end of the blue region B are in contact with each other. The right end of the blue region B and the left end of the green region G are in contact with each other.

In the first embodiment, a case where the red region R is provided on the left side of the blue region B, and the green region G is provided on the right side has been described, but the invention is not limited thereto. The green region G may be provided on the left side of the blue region B, and the red region R may be provided on the right side.

As illustrated in FIG. 3(a), a perspective located in a first direction D1 in which each of the red region R and the green region G of the second cell C2 is viewed so as to abut on the blue region B of the first cell C1, specifically, a location directly above the display medium 1 is set as a first perspective. The user is capable of viewing each of the blue region B, the red region R, and the green region G from the first perspective. The display medium 1 displays the first content using the red region R, the green region G, and the blue region B at the first perspective. The display medium 1 is capable of displaying a content expressed with three primary colors of light of red, green, and blue (RGB) on the upper side.

As illustrated in FIG. 3(b), a perspective located in a second direction D2 in which the green region G of the second cell C2 and the blue region B of the first cell C1 overlap each other, specifically, a location on the left oblique upper side of the display medium 1 is set as a second perspective. The user is capable of viewing the red region R from the second perspective. The green region G is masked with the blue region B. The superimposed region of the blue region B and the green region G absorbs all the colors of red, green, and blue, and displays black, and thus, the user is not capable of viewing either the blue region B or the green region G. The display medium 1 displays the second content using the red region R at the second perspective.

As illustrated in FIG. 3(c), a perspective located in a third direction D3 in which the red region R of the second cell C2 and the blue region B of the first cell C1 overlap each other, specifically, a location on the right oblique upper side of the display medium 1 is set as a third perspective. The user is capable of viewing green region G from the third perspective. The red region R is masked with the blue region B. The superimposed region of the blue region B and the red region R absorbs all the colors of red, green, and blue, and displays black, and thus, the user is not capable of viewing either the blue region B or the red region R. The display medium 1 displays the third content using the green region G at the third perspective.

Note that it is preferable that the first perspective, the second perspective, and the third perspective are at the same distance from the display medium 1 in the Z-axis direction and at different locations in the X-axis direction.

Next, in each of the color regions, a method for expressing a color to be expressed with a pair of the first cell C1 and the second cell C2 will be described. Each of the blue region B of the first cell C1, the red region R of the second cell C2, and the green region G of the second cell C2 includes a plurality of pixels. In the first embodiment, each of the blue region B, the red region R, and the green region G includes the plurality of pixels with the same number and the same shape. In the first embodiment, in the plurality of pixels, the intensity of the color is expressed with the number of colors that color the region. Blue that is applied to the blue region B of the first cell C1, red that is applied to the red region R of the second cell C2, or green that is applied to the green region G of the second cell C2 may be blue, red, or green of three primary colors, or may be a color of which the hue, the intensity, the saturation, or the like is changed from such three primary colors.

A value when the color to be expressed with the pair of the first cell C1 and the second cell C2 is decomposed into three primary colors of light of RGB is calculated. In the plurality of pixels of each of the regions, pixels corresponding in number to each value of red, green, and blue of colors displayed in the first cell C1 and the second cell C2 are colored with red, green, or blue, respectively, and the other pixels are colored with a black color.

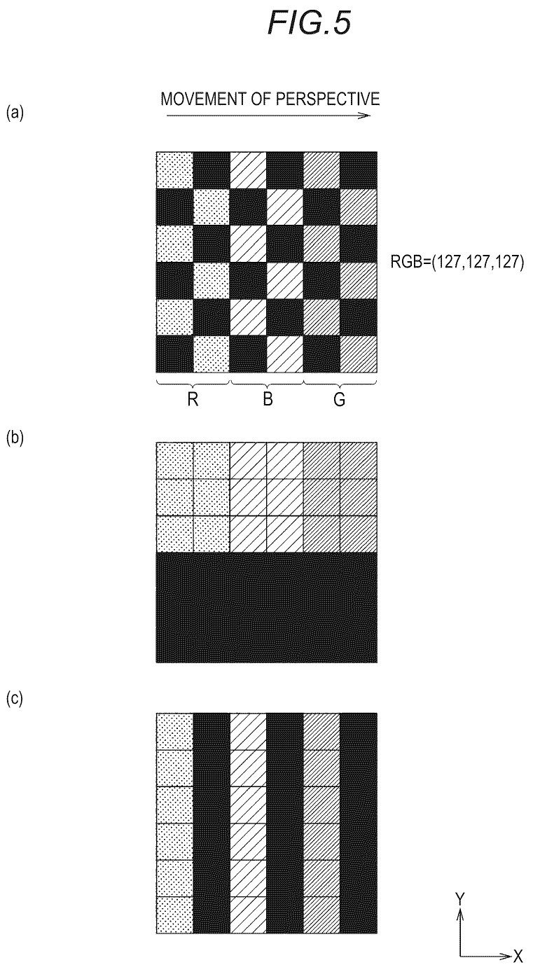

For example, as illustrated in FIG. 4 and FIG. 5, in a case where each of the color regions is expressed with 12 pixels, each of the color regions is expressed with the number of pixels that color the region in 13 gradations from 0 pixels to 12 pixels. The color to be expressed with the pair of the first cell C1 and the second cell C2 is expressed in 256 gradations from 0 to 255.

FIG. 4(a) illustrates a case of RGB=(255, 255, 255). In FIG. 4(a), each pixel of each color region is colored with the color of the color region. Each of 12 pixels of the blue region B is colored with blue. Each of 12 pixels of the red region R is colored with red. Each of 12 pixels of the green region G is colored with green.

FIG. 4(b) illustrates a case of RGB=(255, 0, 255). In FIG. 4(b), there is no color to be expressed with the green region G, and each pixel of the blue region B and the red region R is colored with the pixel of the color region. 12 pixels of the blue region B are colored with blue, 12 pixels of the red region R are colored with red, and 12 pixels of the green region G are colored with black.

FIG. 5(a) to (c) each illustrate a case of RGB=(127, 127, 127). In this case, in each of the color regions, half is colored with the color of the region, and the remaining half is colored with black. In the first embodiment, the region to be colored may be determined in an arbitrary manner.

In FIG. 5(a), a black region is provided into the shape of a checkerboard. In FIG. 5(b), the black region is provided in half in a Y direction. In FIG. 5(c), the black region is provided in a line in an X direction of each region. In the example illustrated in FIG. 5, a case where the black regions of each of the color regions are similarly provided has been described, but the invention is not limited thereto. For example, the black region may be provided in an arbitrary combination such as the blue region B provided as illustrated in FIG. 5(a), the red region R provided as illustrated in FIG. 5(b), and the green region provided as illustrated in FIG. 5(c). In addition, regularity is not required for the black region, and the black region may be randomly provided.

Note that in the first embodiment, a case where the pixel that is not colored with red, green, or blue is colored with the black color has been described, but the invention is not limited thereto. The pixel that is not colored with red, green, or blue may be colored with a color other than red, green, and blue (a color that is not blue, red, or green).

The display medium 1 displays a content expressed with the red region R and a content expressed with the green region G in addition to the content expressed with the blue region B, the red region R, and the green region G. The able-bodied individual views the content expressed with the blue region B, the red region R, and the green region G. The minority color vision carrier with a middle wave sensitive cone dysfunction or a long wave sensitive cone dysfunction is capable of viewing the composition of the content by changing the perspective and repeatedly viewing the second content expressed with the red region R and the third content expressed with the green region G.

In the first embodiment, by alternately changing the perspective on the display medium 1 between the perspective for viewing the second content and the perspective for viewing the third content, specifically, changing the perspective on the display medium 1 from an upper-left oblique direction to an upper-right oblique direction, the minority color vision carrier is capable of perceiving the composition from the contrasting density appearing in the composition of each of the red region R and the green region G.

### Processing Device

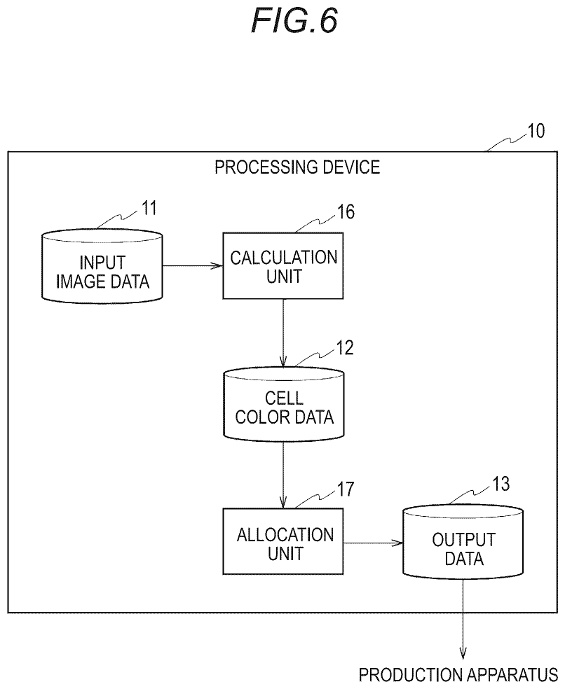

A processing device 10 determining colors to be applied to the display medium 1 will be described with reference to FIG. 6. The processing device 10 has each piece of data such as input image data 11, cell color data 12, and output data 13, and each function of a calculation unit 16 and an allocation unit 17. Each piece of data is stored in a storage device such as a memory 902 or a storage 903. Each function is implemented in a CPU 901.

The input image data 11 is an image of the content displayed on the display medium 1. The input image data 11 includes a plurality of pixels, and associates each of the pixels with a predetermined color.

The cell color data 12 is data of a color to be expressed with each pair of cells of the display medium 1.

The output data 13 is data for associating the value of a color to be printed on each layer with the location thereof when forming the display medium 1 by the production apparatus. The output data 13, for each pair of cells, associates the pixel colored with the blue color and the pixel colored with the black color in the first cell C1 of the pair, and the pixel colored with the red color, the pixel colored with the green color, and the pixel colored with the black color in the second cell C2.

The calculation unit 16 calculates each value of red, green, and blue (RGB) of colors displayed in the first cell C1 and the second cell C2 of one pair of cells in the first content expressed with RGB. The calculation unit 16 calculates the values of RGB corresponding to the location of the pair of the input image data 11, which is a processing target, as the values of RGB of the colors displayed in the first cell C1 and the second cell C2 of the pair. The calculation unit 16 calculates the values of RGB for each pair of cells, and outputs the values to the cell color data 12.

The allocation unit 17 determines the pixels for allocating each color to each of the blue region B, the red region R, and the green region G for each pair of cells, and outputs the pixels to the output data 13. The allocation unit 17, for the pair of cells, which are the processing target, allocates red to pixels corresponding in number to the calculated value of red, and allocates black to the other pixels, in the plurality of pixels of the red region R. The allocation unit 17 allocates green to pixels corresponding in number to the calculated value of green, and allocates black to the other pixels, in the plurality of pixels of the green region G. The allocation unit 17 allocates blue to pixels corresponding in number to the calculated value of blue, and allocates black to the other pixels, in the plurality of pixels of the blue region B.

It is assumed that the calculation unit 16 calculates BRG=(150, 50, 100) for the pair of cells, which are the processing target. Here, each value of RGB is the value of an integer of 0 to 255, and each of the red region R, the green region G, and the blue region B is formed of 12 pixels.

The number corresponding to the value of blue, specifically, the number of pixels allocated to blue in the blue region B is a value in a step corresponding to the value of blue when a value range of 0 to 255 available to the value of blue is divided into steps by the number of pixels of the blue region B, which is 12, +1.

A value obtained by dividing a value of 150 of B by the number of gradations of 256 is 0.58. A value obtained by multiplying the number of gradations of 13 that can be expressed with the pixel of the blue region B by a value of 0.58 is 7.54. Accordingly, the allocation unit 17, among 12 pixels of the blue region B, allocates red to 8 pixels, and allocates black to the remaining 4 pixels. Note that in the disclosure, the values are rounded off to be an integer.

The number corresponding to the value of red, specifically, the number of pixels allocated to red in the red region R is a value in a step corresponding to the value of red when a value range of 0 to 255 available to the value of red is divided into steps by the number of pixels of the red region R, which is 12, +1.

A value obtained by dividing the value of 50 of R by the number of gradations of 256 is 0.19. A value obtained by multiplying the number of gradations of 13 that can be expressed with the pixel of the red region R by a value of 0.19 is 2.47. Accordingly, the allocation unit 17, among 12 pixels of the red region R, allocates red to 2 pixels, and allocates black to the remaining 10 pixels.

The number corresponding to the value of green, specifically, the number of pixels allocated to green in the green region G is a value in a step corresponding to the value of green when a value range of 0 to 255 available for the value of green is divided into steps by the number of pixels of the green region G, which is 12, +1.

A value obtained by dividing the value of 100 of G by the number of gradations of 256 is 0.39. A value obtained by multiplying the number of gradations of 13 that can be expressed with the pixel of the green region G by a value of 0.39 is 4.68. Accordingly, the allocation unit 17, among 12 pixels of the green region G, allocates red to 5 pixels, and allocates black to the remaining 7 pixels.

Note that 8 pixels are colored in the blue region B, 2 pixels are colored in the red region R, and 5 pixels are colored in the green region G, and the other pixels are colored with black, and thus, a ratio of blue, red, and green is 8:2:5. The ratio of blue, red, and green approximates to a ratio of BRG of 150:50:100, which is calculated from the input image data 11.

In a case where the number of pixels to which red, green, or blue is allocated is determined for the pair of cells, which are the processing target, the allocation unit 17 determines which pixel is colored with the color of the region. The allocation unit 17 determines the pixel to which the color of the region is allocated randomly based on or in accordance with a predetermined rule. The allocation unit 17, for each pair of cells, specifies the pixel of the color that is colored with the color of each region, and generates the output data 13.

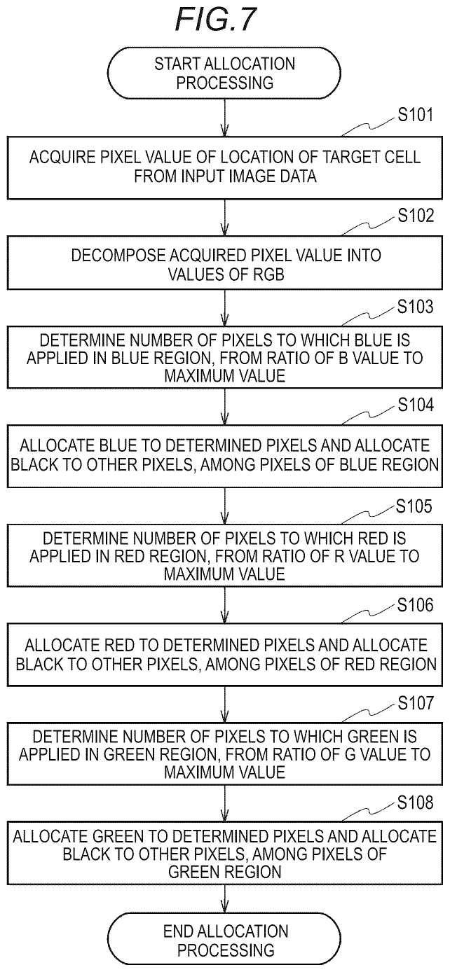

Processing of allocating blue, red, green, or black to the pixels of each of the blue region B, the red region R, and the green region G for the pair of cells, which are the predetermined target, will be described with reference to FIG. 7.

First, in step S101, the processing device 10 acquires the pixel value of the location of the pair of cells, which are the processing target, from the input image data 11. In step S102, the processing device 10 decomposes the pixel value acquired in step S101 into the values of RGB.

In step S103, the processing device 10 determines the number of pixels to which blue is applied in the blue region B, from a ratio of the B value to the maximum value of the B value. In step S104, the processing device 10, among the pixels of the blue region B, allocates blue to the number of pixels determined in step S103, and allocates black to the other pixels.

In step S105, the processing device 10 determines the number of pixels to which red is applied in the red region R, from a ratio of the R value to the maximum value of the R value. In step S106, the processing device 10, among the pixels of the red region R, allocates red to the number of pixels determined in step S105, and allocate black to the other pixels.

In step S106, the processing device 10 determines the number of pixels to which green is applied in the green region G, from a ratio of the G value to the maximum value of the G value. In step S107, the processing device 10, among the pixels of the green region G, allocates red to the number of pixels determined in step S106, and allocates black to the other pixels.

The processing device 10 repeats the processing illustrated in FIG. 7 for each pair of cells, and outputs a corresponding relationship between the pixel and the color in each pair to the output data 13. By inputting the output data 13 to the production apparatus such as a printer, the first layer L1 and the second layer L2 in which each pixel is colored with a suitable color are output. The display medium 1 is formed from the base material M, the second layer L2, and the third layer.

The display medium 1 according to the first embodiment is capable of displaying the content that is easily viewable for both of the able-bodied individual and the minority color vision carrier while saving the space.

### Second Embodiment

The display medium 1 according to a second embodiment has the configuration of the display medium described in PTL 2, as with the display medium 1 according to the first embodiment.

In the first embodiment, a case where the display medium 1 is generated by using a printer or the like has been described, but in the first embodiment, the transmissiveness of the ink is not considered, and the dye ink or the pigment ink can be used. In the second embodiment, the display medium 1 in the case of using a non-transmissive ink, such as a pigment ink, will be described. The pigment ink does not have transmissiveness, and thus, the colored portion of the first layer L1 can be disposed to overlap with the colored portion of the second layer L2.

The first cell C1 of the first layer L1 has the blue region B in the center. The second cell C2 of the second layer L2 has the red region R and the green region G so as to overlap with the blue region B. In the second embodiment, the left side of the center of the blue region B overlaps with the red region R, and the right side overlaps with the green region G. A part of the right side of the red region R overlaps with the blue region B. A part of the left side of the green region overlaps with the blue region B. In the second embodiment, the red region R and the green region G of the second layer L2 are formed to be wider than the blue region B of the first layer L1 (wider in the X direction).

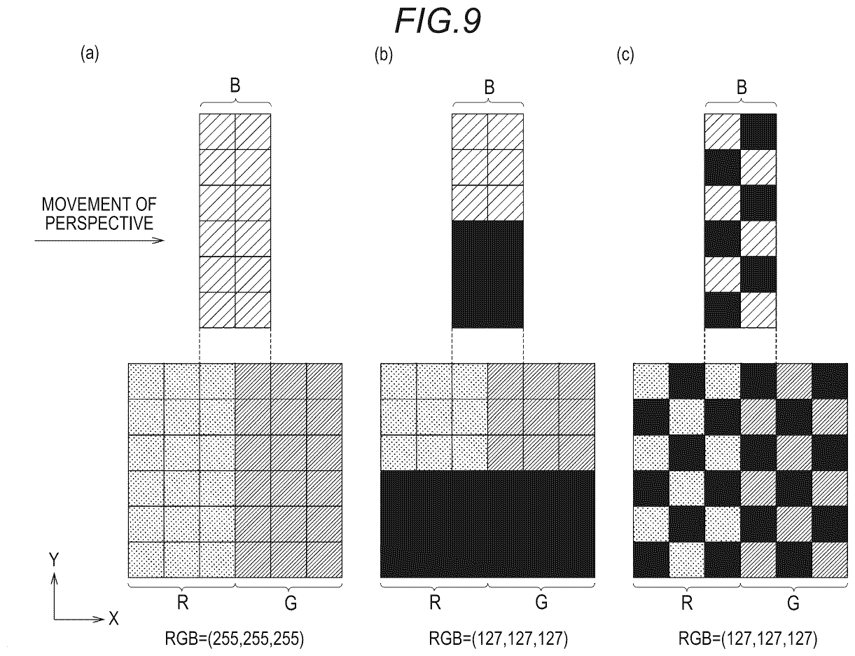

FIG. 9(a) illustrates the colored portion of each of the first layer L1 and the second layer L2. In FIG. 9, the upper part illustrates the blue region of the first layer L1, and the lower part illustrates the red region R and the green region G of the second layer L2. A dashed-dotted line connecting the upper part and the lower part illustrates the corresponding location of each color region when the first layer L1 and the second layer overlap each other.

As illustrated in FIG. 9(a), the blue region B includes 6 pixels*2 columns=12 pixels, and each of the red region R and the green region G includes 6 pixels*3 columns=18 pixels. The rightmost column of the red region R is superimposed on the left column of the blue region B. The leftmost column of the green region G is superimposed on the right column of the blue region B.

In the second embodiment, a case where the red region R is provided on the left side of the blue region B, and the green region G is provided on the right side has been described, but the invention is not limited thereto. The green region G may be provided on the left side of the blue region B, and the red region R may be provided on the right side.

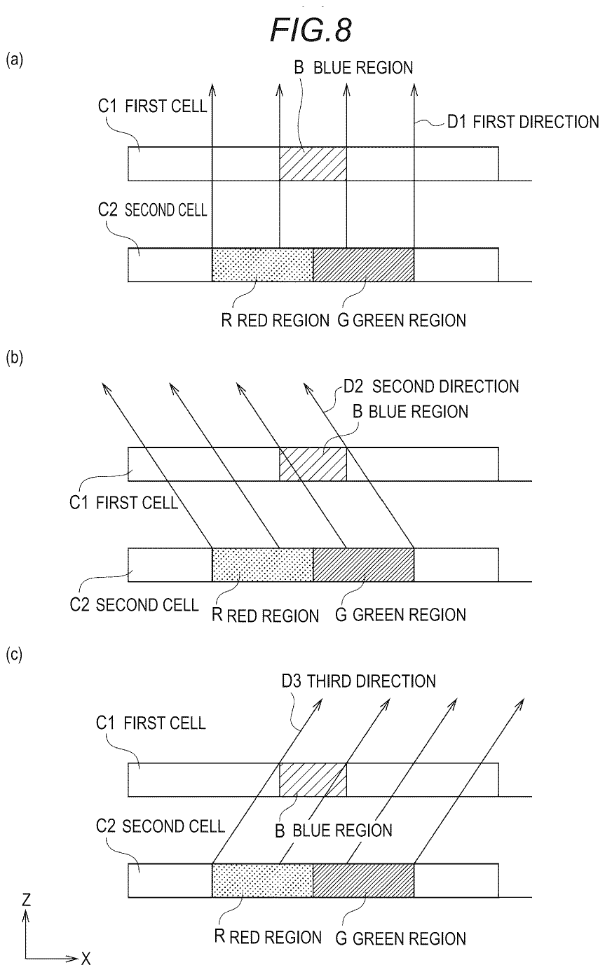

As illustrated in FIG. 8(a), the perspective located in the first direction D1 in which each of the red region R and the green region G of the second cell C2 is viewed so as to abut on the blue region B of the first cell C1, specifically, the location directly above the display medium 1 is set as the first perspective. The user is capable of viewing each of the blue region B, the red region R, and the green region G from the first perspective. The left end of the blue region B is located in the center of the red region R in a right-left direction. The right end of the blue region B is located in the center of the green region G in the right-left direction.

The display medium 1 displays the first content using the red region R, the green region G, and the blue region B at the first perspective. The display medium 1 is capable of displaying the content expressed with three primary colors of light of red, green, and blue (RGB) on the upper side.

As illustrated in FIG. 8(b), the perspective located in the second direction D2 in which the green region G of the second cell C2 and the blue region B of the first cell C1 overlap each other, specifically, the location on the left oblique upper side of the display medium 1 is set as the second perspective. The user is capable of viewing the red region R and the blue region B from the second perspective. The green region G is masked with the blue region B, and thus, the user is not capable of viewing the green region G. The display medium 1 displays the second content using the red region R and the blue region B at the second perspective. Here, the minority color vision carrier does not react to the blue region B, and thus, view the second content displayed using red region R.

As illustrated in FIG. 8(c), the perspective located in the third direction D3 in which the red region R of the second cell C2 and the blue region B of the first cell C1 overlap each other, specifically, the location on the right oblique upper side of the display medium 1 is set as the third perspective. The user is capable of viewing the green region G and the blue region B from the third perspective. The red region R is masked with the blue region B, and thus, the user is not capable of viewing the red region R. The display medium 1 displays the third content using the green region G and the blue region B at the third perspective. Here, the minority color vision carrier does not react to the blue region B, and thus, views the third content displayed using the green region B.

In the display medium 1 according to the second embodiment, it is possible to display the content that is easily viewable for both of the able-bodied individual and the minority color vision carrier while saving the space, as with the display medium 1 according to the first embodiment.

In the first embodiment, the blue region B and the green region G or the blue region B and the red region R overlap each other from the second perspective and the third perspective illustrated in FIG. 3(b) and (c). In the first embodiment, the blue region B, the red region R, and the green region G have the same shape, and thus, the perspective where such regions overlap each other is in a limited range in the X direction, and a location where suitable red-based content and green-based content can be viewed is narrowed.

In contrast, in the second embodiment, the red region R and the green region G are wider than the blue region B, and thus, a range in which the blue region B and the green region G or the blue region B and the red region R overlap each other is a wide range in the X-axis direction, and a location where suitable red-based content and green-based content can be viewed is widened. For example, a perspective in a direction in which 2 columns of the blue region B overlap with 2 columns on the left side or 2 columns on the right side in 3 columns of the red region R is the second perspective. Similarly, a perspective in a direction in which 2 columns of the blue region B overlaps with 2 columns on the left side or 2 columns on the right side in 3 columns of the green region G is the third perspective.

Accordingly, in the display medium 1 according to the second embodiment, it is easy to adjust the location where the red-based content and the green-based content are viewed, and it is possible to expect to reduce the burden on the minority color vision carrier, compared to the display medium 1 according to the first embodiment.

In the second embodiment, the number of pixels colored with blue, red, or green, or the number of pixels colored with black is calculated in each region, as with the first embodiment. Here, in the second embodiment, at the second perspective or the third perspective, the red region R or the green region G overlapping with the blue region B is variable. In each column in a direction (a Y-axis direction) orthogonal to the movement direction of the perspective (the X-axis direction), it is necessary that the ratio of the pixels to which each color of blue, red, or green is allocated and the ratio of the pixels to which black is allocated are the same. The movement direction of the visual line is a direction connecting the second perspective for viewing the red-based content for the minority color vision carrier and the second perspective for viewing the green-based content.

FIG. 9(b) to (c) each illustrate a case of RGB=(127, 127, 127). In this case, in each of the color regions, half is colored with the color of the region, and the remaining half is colored with black. Here, in the second embodiment, in each column, the ratio of the pixels to which each color is allocated and the ratio of the pixels to which black is allocated are the same. The regions may be provided in an arbitrary manner insofar as the ratios of such pixels are the same. For example, for example, the black region may be provided in an arbitrary combination such as the blue region B provided as illustrated in FIG. 9(a), and the red region R and the green region G provided as illustrated in FIG. 9(c). In addition, regularity is not required for the black region, and the black region may be randomly provided.

Here, as illustrated in FIG. 5(c), in each column in the Y-axis direction, a variation in the number of pixels to which the color is applied and the number of pixels to which black is applied is not allowed, but when viewed from the second perspective, the contrasting density of the red-based content is changed in accordance with the location of the perspective, similarly, when viewed from the third perspective, the contrasting density of the green-based content is changed in accordance with the location of the perspective.

The processing device 10 determining the color to be applied to the display medium 1 according to the second embodiment is as described with reference to FIG. 6. Here, the allocation unit 17 is different from that in FIG. 6 in that in each column in the direction (the Y-axis direction) orthogonal to the movement direction of the perspective (the X-axis direction), the ratio of the pixels to which each color of blue, red, or green is allocated, and the ratio of the pixels to which black is allocated are the same.

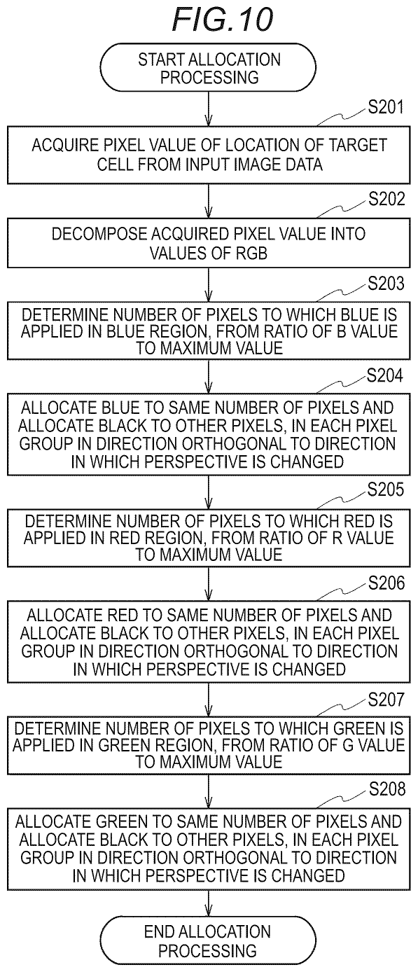

Processing of allocating blue, red, green, or black to the pixels of each of the blue region B, the red region R, and the green region G for the pair of cells, which are the predetermined target, will be described with reference to FIG. 10.

The processing of step S201 and step S202 is the same as that of step S101 and step S102 in FIG. 6.

In step S203, the processing device 10 determines the number of pixels to which blue is applied in the blue region B, from the ratio of the B value to the maximum value of the B value. In step S204, the processing device 10, among the pixels of the blue region B, allocates blue to the number of pixels determined in step S203, and allocates black to the other pixels. In this case, the processing device 10, in each pixel group in a direction orthogonal to a direction in which the perspective is changed, allocates blue to the same number of pixels, and allocates black to the other pixels.

In step S205, the processing device 10 determines the number of pixels to which red is applied in the red region R, from the ratio of the R value to the maximum value of the R value. In step S206, the processing device 10, among the pixels of the red region R, allocates red to the number of pixels determined in step S105, and allocates black to the other pixels. In this case, the processing device 10, in each pixel group in the direction orthogonal to the direction in which the perspective is changed, allocates red to the same number of pixels, and allocates black to the other pixels.

In step S206, the processing device 10 determines the number of pixels to which green is applied in the green region G, from the ratio of the G value to the maximum value of the G value. In step S207, the processing device 10, among the pixels of the green region G, allocates green to the number of pixels determined in step S206, and allocates black to the other pixels. In this case, the processing device 10, in each pixel group in the direction orthogonal to the direction in which the perspective is changed, allocates green to the same number of pixels, and allocates black to the other pixels.

The processing device 10 repeats the processing illustrated in FIG. 7 for each pair of cells, and outputs the corresponding relationship between the pixel and the color in each pair to the output data 13. By inputting the output data 13 to the production apparatus such as a printer, the first layer L1 and the second layer L2 in which each pixel is colored with a suitable color are output. In this case, the printer prints a predetermined color on the first layer L1 and the second layer L2 with the non-transmissive ink such as a pigment ink. The display medium 1 is formed from the base material M, the second layer L2, and the third layer.

The display medium 1 according to the second embodiment is capable of displaying the content that is easily viewable for both of the able-bodied individual and the minority color vision carrier while saving the space. In addition, in the display medium 1 according to the second embodiment, the range in which the red-based content or the green-based content is viewed is wide, and thus, the burden for adjusting the perspective on the user is reduced, compared to the display medium 1 according to the first embodiment.

### Third Embodiment

In the first embodiment and the second embodiment, a case where the display medium is formed by using the technology described in PTL 2 has been described. In a third embodiment, a case where a display medium 100 is formed by using the technology described in PTL 1 will be described.

The display medium 100 according to the third embodiment displays a content visible to the able-bodied individual and the minority color vision carrier. The display medium 100 displays three contents corresponding to three azimuthal angles from predetermined elevation angle and azimuthal angle.

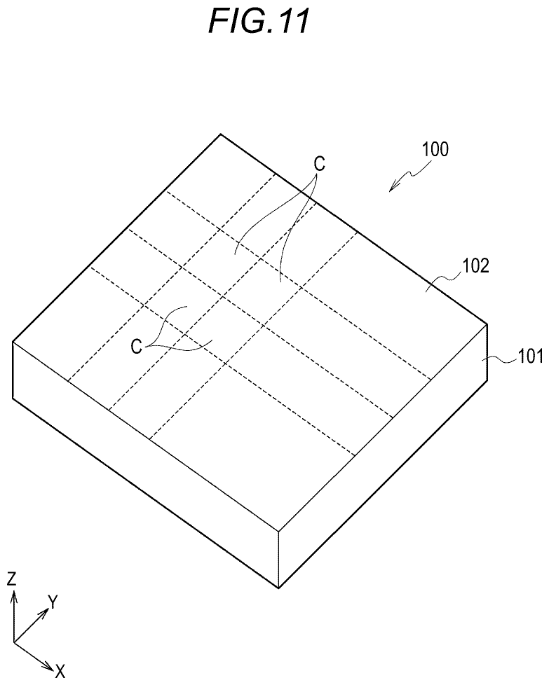

As illustrated in FIG. 11, the display medium 100 includes a base material 101, and a colored portion 102 for expressing the color of a content on the upper surface of the base material 101. The base material 101 has a surface for reflecting light. The base material 101 may be in a thin sheet shape such as paper, or may be in a three-dimensional shape. The upper surface of the base material 101 may be a flat surface, or may be a curved surface.

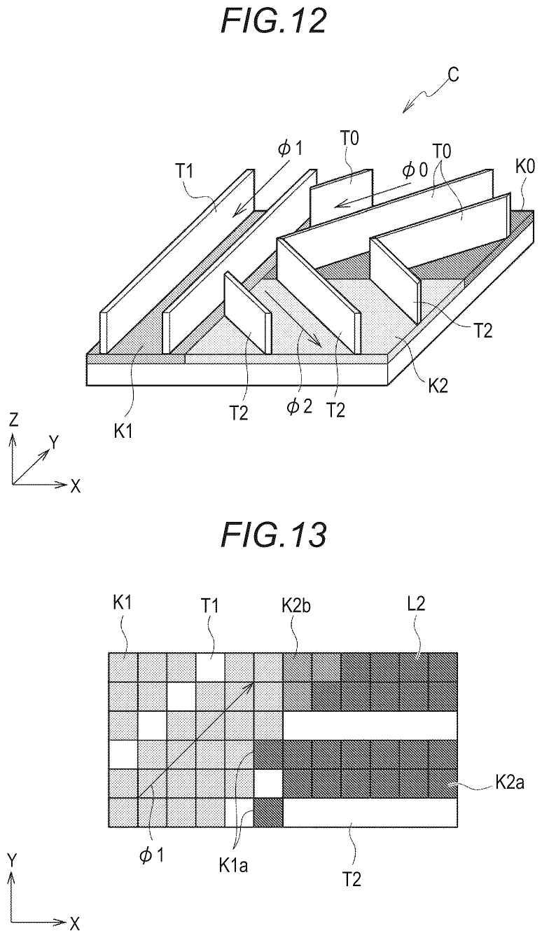

The upper surface of the base material 101 is divided into the plurality of cells C. The plurality of cells may be adjacent to each other, or may be separated from each other. Each of the plurality of cells C, as illustrated in FIG. 12, is divided into three subcells K0, K1, and K2 respectively corresponding to three azimuthal angles. The subcell K0 corresponds to an azimuthal angle φ0. The subcell K1 corresponds to an azimuthal angle φ1. The subcell K2 corresponds to an azimuthal angle φ2.

Protruding members T0, T1, and T2 are formed in the subcells K0, K1, and K2 corresponding to a predetermined azimuthal angle, respectively. The protruding member T0 is formed in the subcell K0. The protruding member T1 is formed in the subcell K1. The protruding member T2 is formed in the subcell K2.

The protruding members T0, T1, and T2 are formed of a member for shielding light. The protruding members T0, T1, and T2 has a surface in a predetermined azimuthal angle direction, more specifically, a surface parallel to the azimuthal angle corresponding to the subcell in which the protruding member is formed.

The colored portion of the subcell corresponding to the predetermined azimuthal angle is observed from the predetermined elevation angle and the azimuthal angle.

For example, in a case where the user observes a coordinate x on the display medium 100 at the predetermined elevation angle ω0 and the azimuthal angle φ0, it is possible to check the color value of the coordinate of the first content corresponding to the coordinate x on the display medium 100. Similarly, in a case where the user observes the coordinate x on the display medium 100 at the predetermined elevation angle ω1 and the azimuthal angle φ1, it is possible to check the color value of the coordinate of the second content corresponding to the coordinate x on the display medium 100. Further, in a case where the user observes the coordinate x on the display medium 100 at the predetermined elevation angle ω2 and the azimuthal angle φ2, it is possible to check the color value of the coordinate of the third content corresponding to the coordinate x on the display medium 100.

In the third embodiment, a case where the first content is displayed at the azimuthal angle φ0, the second content is displayed at the azimuthal angle φ2, and the third content is displayed at the azimuthal angle φ3 has been described, but the invention is not limited thereto. An association between the azimuthal angle and the content to be displayed is suitably determined.

The cell C of the coordinate x will be described with reference to FIG. 12. The cell C includes the subcell K0, the subcell K1, and the subcell K2. In the subcell K0, three protruding members T0 are disposed in parallel to the direction of the azimuthal angle φ0. In the subcell K1, two protruding members T1 are disposed in parallel to the direction of the azimuthal angle φ1. In the subcell K2, three protruding members T2 are disposed in parallel to the direction of the azimuthal angle φ2.

The protruding member T has a predetermined height, and thus, when the display medium 1 is observed from a certain elevation angle, there are a portion that is shielded by the protruding member T and a portion that is not shielded. In a case where the user observes the display medium from the azimuthal angle φ0, the colored portion 102 of the subcell K0 in which the protruding member T0 parallel to the azimuthal angle φ0 is formed is visible, but the colored portion 102 of the other subcell K1 or K2 is difficult to view. In a case where user observes the display medium from the azimuthal angle φ1, the colored portion 102 of the subcell K1 in which the protruding member T1 parallel to the azimuthal angle φ1 is formed is visible, but the colored portion 102 of the other subcell K0 or K2 is difficult to view. In a case where user observes the display medium from the azimuthal angle φ2, the colored portion 102 of the subcell K2 in which the protruding member T2 parallel to the azimuthal angle φ2 is formed is visible, but the colored portion 102 of the other subcell K0 or K1 is difficult to view.

Such a display medium 100 according to the third embodiment is capable of displaying three contents in three directions. The display medium 100 is capable of displaying the first content that can be expressed with three primary colors of red, green, and blue at the first perspective on the azimuthal angle φ. The display medium 100 is capable of displaying the second content in which the red component is extracted from the first content at the second perspective on the azimuthal angle φ1. The display medium 100 is capable of displaying the third content in which the green component is extracted from the first content at the third perspective on the azimuthal angle φ2.

Note that in the third embodiment, it is ideal that the user is capable of checking each pixel of the colored portion 102 of the subcell corresponding to the azimuthal angle and is not capable of checking each pixel of the colored portion 102 of the subcell not corresponding to the azimuthal angle when viewing the display medium from the predetermined azimuthal angle, but it may not be the case.

As illustrated in FIG. 13, a case where the protruding member T1 is formed in the subcell K1 will be considered. In a case where the user observes the display medium from a ω1 direction parallel to the protruding member T1, it is possible to check almost all the pixels in the subcell K1. However, a shielded portion K1a, which is an unobserved pixel, is formed in the subcell K1. In addition, an exposed portion K2b, which is an observed pixel, may be formed in the subcell K2 not corresponding to the azimuthal angle φ1. Therefore, in the processing of an allocation unit 117 described below, a pixel group viewed at each perspective is specified, and the colors are allocated to the specified pixel group to be displayed at the perspective.

Next, a processing device 110 allocating the color to each pixel of the display medium 100 will be described.

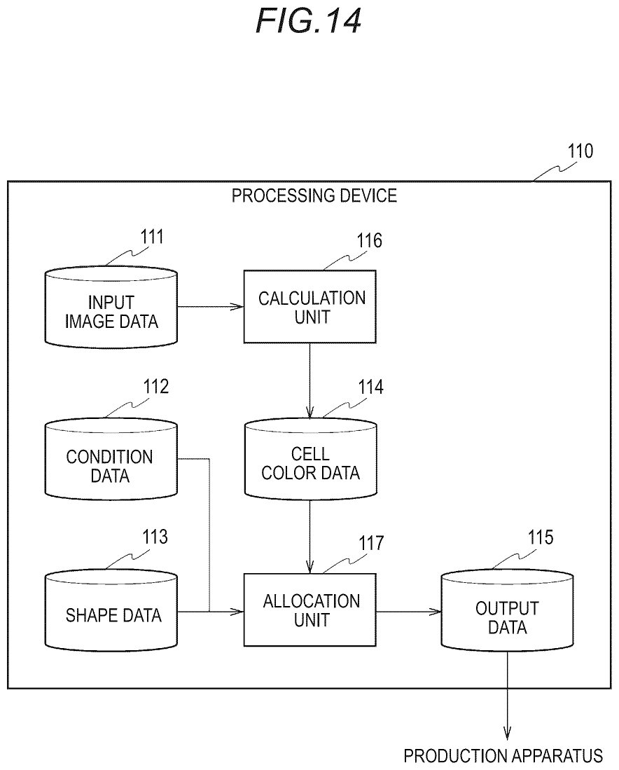

As illustrated in FIG. 14, the processing device 110 has each piece of data such as input image data 111, condition data 112, shape data 113, cell color data 114, and output data 115, and each function of a calculation unit 116 and the allocation unit 117. Each piece of data is stored in the storage device such as the memory 902 or the storage 903. Each function is implemented in the CPU 901.

The input image data 111, the cell color data 114, and the output data 115 are the same as the input image data 11, the cell color data 12, and the output data 13 in FIG. 6. The processing of the calculation unit 116 is the same as the processing of the calculation unit 16 in FIG. 6.

The condition data 112 is data for specifying the azimuthal angle and the elevation angle at which the content is displayed on the display medium 100. The shape data 113 is data for specifying the location and the height of the protruding member disposed in each subcell of the display medium 100.

The allocation unit 117 allocates the colors to each pixel in the cell, which is a processing target, such that the color of each value of red, green, and blue is displayed using the pixels viewed from the first perspective in the cell, which is the processing target, the color of the value of red is displayed using the pixels viewed from second perspective in the cell, which is the processing target, and the color of the value of green is displayed using the pixels viewed from the third perspective in the cell, which is the processing target. Here, among the pixels in the cell, which is the processing target, the pixel to which the color is allocated is a pixel in which the protruding member is not formed.

The allocation unit 117, among the pixels in the cell, which is the processing target, specifies each of the pixel group viewed from the first perspective, the pixel group viewed from the second perspective, and the pixel group viewed from the third perspective. For example, in the example of FIG. 13, the pixel that is viewed when viewed from the azimuthal angle φ1 includes the exposed portion K2b in the subcell K2, and does not include the shielded portion K1a in the subcell K1.

The allocation unit 117, in each of the pixel groups, allocates the color to each pixel such that the values of RGB to be expressed with the cell, which is the processing target, and the values of red and green of the values of RGB can be expressed. In this case, the color of each pixel may be optimized such that the luminance of each of the subcells is the same.

The processing device 110 repeats the processing of allocating the color to each pixel for each cell, and outputs the corresponding relationship between the pixel and the color in each cell to the output data 115. By inputting the output data 115 to the production apparatus such as a printer, the display medium 100 in which each pixel is colored with a suitable color is output. The printer may be a 3D printer that is also capable of forming the protruding member.

The display medium 100 according to the third embodiment is capable of displaying the content that is easily viewable for both of the able-bodied individual and the minority color vision carrier while saving the space, as with the display medium 1 according to the first or second embodiment.

### Technology A

A display medium capable of displaying three contents corresponding to three azimuthal angles, for a predetermined elevation angle and three perspectives respectively corresponding to the three azimuthal angles,
in which the content displayed on the display medium is expressed with colors applied to each of a plurality of pixels,
a first content that can be expressed with three primary colors of red, green, and blue is displayed using pixels viewed from a first perspective among the plurality of pixels,
a second content in which a red component is extracted from the first content is displayed using pixels viewed from a second perspective among the plurality of pixels,
a third content in which a green component is extracted from the first content is displayed using pixels viewed from a third perspective among the plurality of pixels, and
a minority color vision carrier with a middle wave sensitive cone dysfunction or a long wave sensitive cone dysfunction is capable of viewing the composition of the content by changing the perspective and repeatedly viewing the second content and the third content.

### Technology B

A display medium capable of displaying three contents corresponding to three azimuthal angles, for a predetermined elevation angle and the three azimuthal angles, the display medium including
a base material for reflecting light,
in which the base material is divided into a plurality of cells, each of the plurality of cells is divided into three subcells respectively corresponding to the three azimuthal angles,
a protruding member having a surface in a direction of a predetermined azimuthal angle, which shields light, is formed in each subcell corresponding to the predetermined azimuthal angle,
the subcell corresponding to the predetermined azimuthal angle is observed from the predetermined elevation angle and azimuthal angle,
a first content that can be expressed with three primary colors of red, green, and blue is displayed using pixels viewed from a first perspective among a plurality of pixels, a second content in which a red component is extracted from the first content is displayed using pixels viewed from a second perspective among the plurality of pixels, and a third content in which a green component is extracted from the first content is displayed using pixels viewed from the third perspective among the plurality of pixels, and
a minority color vision carrier views the composition of the content by changing the perspective and repeatedly viewing the second content and the third content.

### Technology C

A processing device allocating a color to each pixel of the display medium according to Technology B,
the display medium including a plurality of cells, the processing device including:
a calculation unit calculating each value of red, green, and blue of colors displayed in a predetermined cell in the first content; and
an allocation unit allocating a color to each pixel in the predetermined cell such that a color of each value of red, green, and blue is displayed using the pixels viewed from the first perspective in the predetermined cell,
a color of the value of red is displayed using the pixels viewed from the second perspective in the predetermined cell, and
a color of the value of green is displayed using the pixels viewed from the third perspective in the predetermined cell.

### Fourth Embodiment

In the first embodiment and the second embodiment, a case where the display medium is formed by using the technology described in PTL 2 has been described. In the fourth embodiment, a case where a display medium 200 is formed by using the technology described in PTL 3 will be described.

The display medium 200 according to the fourth embodiment displays the content visible to the able-bodied individual and the minority color vision carrier. The display medium 200 displays three contents corresponding to three azimuthal angles from the predetermined elevation angle and azimuthal angle.

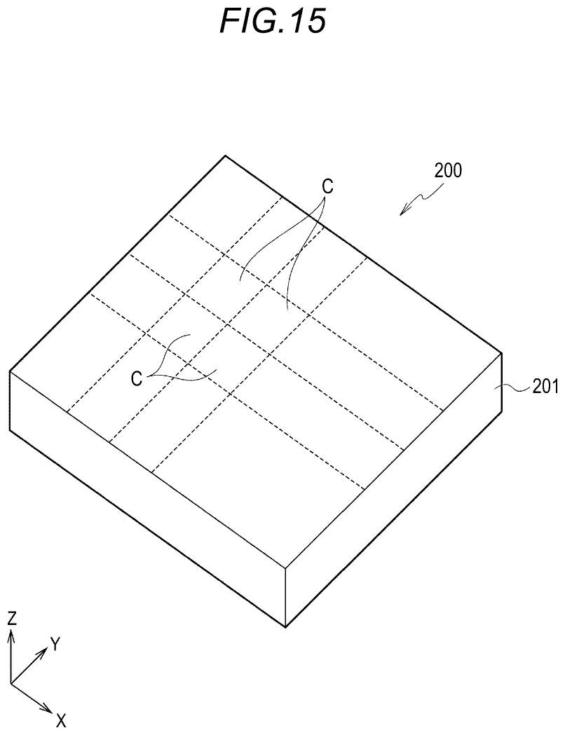

As illustrated in FIG. 15, the display medium 200 includes a base material 201. The base material 201 may be in a thin sheet shape such as paper, or may be in a three-dimensional shape. The upper surface of the base material 201 may be a flat surface, or may be a curved surface.

The upper surface of the base material 101 is divided into the plurality of cells C. The plurality of cells may be adjacent to each other, or may be separated from each other.

In one cell C, one partition P is provided. The partition P is a surface formed on a flat surface intersecting with the base material 201, and has a portion exposed when the display medium 200 is observed in each of three directions. The partition P has a plurality of pixels on the surface.

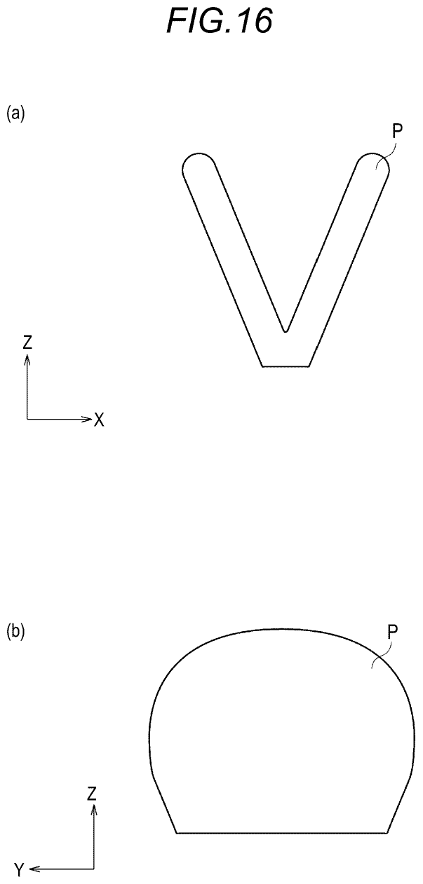

As illustrated in FIG. 16, the partition P is formed to radially divide a space on the cell C for each of three directions from a point on the cell C. In the fourth embodiment, the partition P divides the first perspective, the second perspective, and the third perspective on an X axis above the display medium 200. The partition P may be provided so as to be in contact with the outer edge of the cell C and so as not to be connected to the partition of the adjacent cell. Alternatively, the partition P may be provided so as to be connected to the partition of the adjacent cell C.

The frame of the partition P is a part of a Voronoi surface in a Voronoi diagram in which a point virtually provided on each of three directions is set as a generating point.

The plurality of pixels are provided on the surface of the partition P. The first content that can be expressed with three primary colors of red, green, and blue is displayed using the pixels viewed from the first perspective among the plurality of pixels. The second content in which the red component is extracted from the first content is displayed using the pixels viewed from the second perspective among the plurality of pixels. The third content in which the green component is extracted from the first content is displayed using the pixels viewed from the third perspective among the plurality of pixels.

Note that a combination between the perspective and the content displayed at the perspective is suitably set. For example, a content in which the green component is extracted may be displayed using the pixels viewed from the second perspective, and a content in which the red component is extracted may be displayed using the pixels viewed from the third perspective.

The minority color vision carrier is capable of viewing the composition of the content by changing the perspective and repeatedly viewing the second content and the third content.

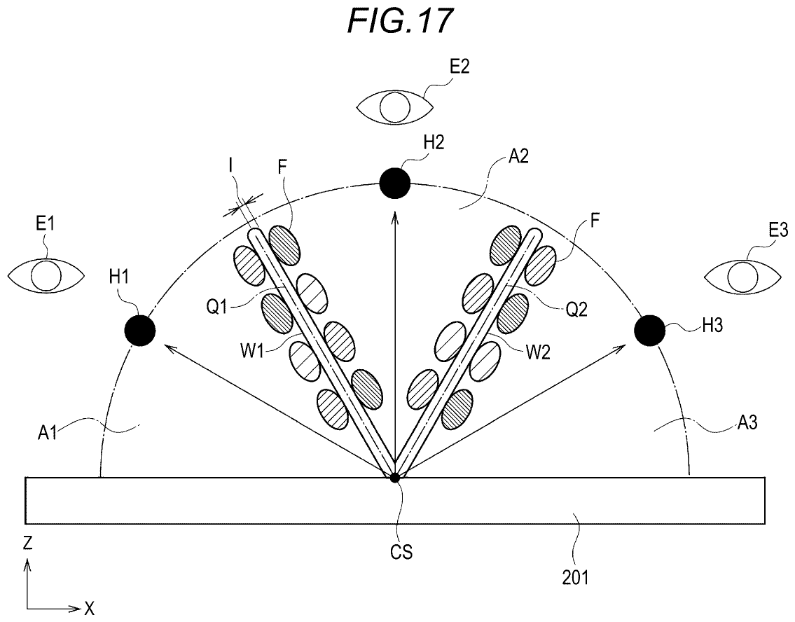

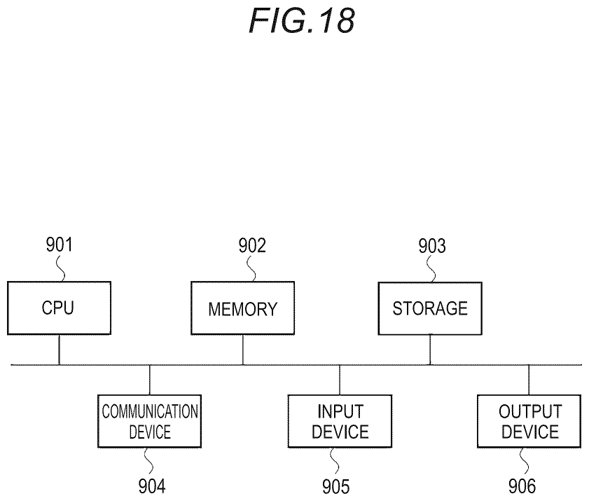

The shape of the partition P will be described with reference to FIG. 17. In the fourth embodiment, the Voronoi diagram for the generating point virtually provided in a direction in which the content is displayed is virtually formed. The partition P includes the Voronoi surface in the Voronoi diagram in the frame. The partition P is obtained by rounding out the Voronoi surface, which is the frame. The surface of the partition P includes a surface parallel to the Voronoi surface.

In the example illustrated in FIG. 17, three perspectives E1, E2, and E3 are provided. Generating points H1, H2, and H3 are provided on a visual line when a center Cs of the cell C is viewed from each of the perspectives E1, E2, and E3. The generating points H1, H2, and H3 are provided on a virtual sphere with a predetermined radius based on the center Cs of the cell C.

The partition P has two shielding members W1 and W2. The shielding members W1 and W2 divide the space on the cell C in which the partition P is provided into three regions.

The shielding member W1 is obtained by rounding out the Voronoi surface Q1 as the frame to have a thickness 1. The shielding member W2 is obtained by rounding out the Voronoi surface Q2 as the frame to have the thickness 1. In addition, the tip of the shielding member W1 is formed into the shape of a circle with a radius 1.

The shielding member W1 divides the space on the cell C into a space A1 corresponding to the perspective E1 and a space A2 corresponding to the perspective E2. The shielding member W2 divides the space on the cell C into the space A2 corresponding to the perspective E2 and a space A3 corresponding to the perspective E2.

A portion of the surface of the partition P exposed when the display medium 1 is observed in a predetermined designated direction in three directions has a portion shielded when the display medium 1 is observed in a direction other than the predetermined designated direction in three designated directions. Even in a case where one pixel F on the surface of the partition P is exposed in one or more directions in three directions, the pixel may not be viewed in the other designated direction. The surface of the partition P expresses the color of the content corresponding to the exposed direction. Accordingly, the display medium 1 is capable of expressing a part of different contents in a plurality of designated directions, and thus, is capable of displaying a plurality of contents with a wide color range and high luminance.

For example, in the example illustrated in FIG. 17, the surface of the shielding member W1 on the space A1 side has a portion that is viewable from the perspective E1 but is not viewable from the perspective E2 or the perspective E3. The surface of the shielding member W1 on the space A2 side has a portion that is viewable from the perspective E2 but is not viewable from the perspective E1 or the perspective E3. The surface of the shielding member W2 on the space A2 side has a portion that is viewable from the perspective E2 but is not viewable from the perspective E1 or the perspective E3. The surface of the shielding member W2 on the space A3 side has a portion that is viewable from the perspective E3 but is not viewable from the perspective E1 or the perspective E2.

Each surface of the partition P is formed so as to be easily viewed in one direction in three directions and hardly viewed in the other two directions. In each surface of the partition P, an effect of producing a color for forming a content in one direction and an effect of shielding light from the other directions are compatible. Accordingly, the display medium 200 is capable of displaying different contents in three directions. In addition, the display medium 200 is capable of displaying a content with a wide color range and high luminance in three directions. In each surface of the partition P, the influence of the visual line in directions other than the designated direction is suppressed, and thus, it is possible to apply a suitable color to a surface observed in the designated direction.

Next, a processing device allocating the color to each pixel of the display medium 200 will be described. The processing device has the same configuration as that of the processing device 110 according to the third embodiment illustrated in FIG. 14.

The condition data 112 is data for specifying the direction in which the content on the display medium 200 is displayed. The shape data 113 is data such as parameters relevant to the partition P of the display medium 200, specifically, the thickness 1 and the size of a virtual half-sphere when the Voronoi surface is cut.

The allocation unit 117 allocates the color to each pixel in the cell, which is the processing target, such that the color of each value of red, green, and blue is displayed using the pixels viewed from the first perspective in the cell, which is the processing target, the color of the value of red is displayed using the pixels viewed from the second perspective in the cell, which is the processing target, and the color of the value of green is displayed using the pixels viewed from the third perspective in the cell, which is the processing target. Here, among the pixels in the cell, which is the processing target, the pixel to which the color is allocated is a pixel in which the protruding member is not formed, and is a pixel viewed from any perspective.

The allocation unit 117, among the pixels of the partition P in the cell, which is the processing target, specifies each of the pixel group viewed from the first perspective, the pixel group viewed from the second perspective, and the pixel group viewed from the third pixel.

The allocation unit 117, in each of the pixel groups, allocates the color to each pixel such that the values of RGB to be expressed with the cell, which is the processing target, and the values of red and green of the values of RGB can be expressed.

The processing device 110 repeats the processing of allocating the color to each pixel for each cell, and outputs the corresponding relationship between the pixel and the color in each cell to the output data 115. By inputting the output data 115 to the production apparatus such as a printer, the display medium 200 in which each pixel is colored with a suitable color is output. The printer may be a 3D printer that is also capable of forming the partition P.

The display medium 200 according to the fourth embodiment is capable of displaying the content that is easily viewable for both of the able-bodied individual and the minority color vision carrier while saving the space, as with the display medium 1 according to the first or second embodiment.

### Technology D

A display medium displaying three contents different from each other in three directions, the display medium including:
a base material including a plurality of virtual cells; and a partition that is a surface formed on a flat surface intersecting with the base material and has a portion exposed when the display medium is observed in each of three directions, in the cell,
in which a frame of the partition includes a part of a Voronoi surface in a Voronoi diagram in which a point virtually provided on each of a plurality of directions is set as a generating point,
a first content that can be expressed with three primary colors of red, green, and blue is displayed using pixels viewed from a first perspective in the plurality of pixels, a second content in which a red component is extracted from the first content is displayed using pixels viewed from a second perspective in the plurality of pixels, and a third content in which a green component is extracted from the first content is displayed using pixels viewed from a third perspective in the plurality of pixels, and
a minority color vision carrier views the composition of the content by changing the perspective and repeatedly viewing the second content and the third content.

### Technology E

A display medium displaying three contents different from each other in three directions, the display medium including:
a base material including a plurality of virtual cells; and
a partition that is a surface formed on a flat surface intersecting with the base material and has a portion exposed when the display medium is observed in each of three directions, in the cell,
in which the partition is provided so as to be in contact with the outer edge of the cell and radially divides a space on the cell in each of the three directions from the cell,
a first content that can be expressed with three primary colors of red, green, and blue is displayed using pixels viewed from a first perspective in the plurality of pixels, a second content in which a red component is extracted from the first content is displayed using pixels viewed from a second perspective in the plurality of pixels, and a third content in which a green component is extracted from the first content is displayed using pixels viewed from a third perspective in the plurality of pixels, and
a minority color vision carrier views the composition of the content by changing the perspective and repeatedly viewing the second content and the third content.

As the processing device 10 of this embodiment described above, for example, a general-purpose computer system including a central processing unit (CPU, a processor) 901, the memory 902, the storage 903 (a hard disk drive (HDD), a solid state drive (SSD)), a communication device 904, an input device 905, and an output device 906 can be used. In such a computer system, by the CPU 901 executing a program loaded on the memory 902, each function of the processing device 10 is attained. Note that as with the processing device 10, the general-purpose computer system can also be used as the processing device 110.

Note that the processing device 10 may be implemented by one computer, or may be implemented by a plurality of computers. In addition, the processing device 10 may be a virtual machine that is implemented in a computer.

The program of the processing device 10 can also be stored in a computer-readable recording medium such as a HDD, a SSD, a universal serial bus (USB) memory, a compact disc (CD), and a digital versatile disc (DVD), or can also be distributed through a network. The computer-readable recording medium, for example, is a non-transitory recording medium.

Note that the disclosure is not limited to the embodiments described above, and various modifications can be available within the scope of the gist.

### REFERENCE SIGNS LIST

1, 100, 200: display medium
10, 110: processing device
11, 111: input image data
12, 114: cell color data
13, 115: output data
16, 116: calculation unit
17, 117: allocation unit
112: condition data
113: shape data
901: CPU
902: memory
903: storage
904: communication device
905: input device
906: output device
A: space
B: blue region
C: cell
G: green region
H: generating point
K: subcell
L: layer
M: base material
N: transparent layer
P: partition
R: red region
T: protruding member
W: shielding member
φ: azimuthal angle

1-8. (canceled)

9. A display medium displaying a content visible to an able-bodied individual and a minority color vision carrier,
the display medium comprising:
a first layer that is formed of a transparent member, has a plurality of cells, and has a blue region in each of the plurality of cells; and
a second layer that is formed of a transparent member, has a plurality of cells, and has a red region and a green region in each of the plurality of cells,
wherein when an overlapping state of a first cell of the first layer and a second cell of the second layer corresponding to the first cell of the first layer is viewed in a predetermined direction, each of the red region and the green region of the second cell is disposed so as to abut on the blue region of the first cell in the predetermined direction,
a first content is displayed using the red region, the green region, and the blue region at a first perspective located in the predetermined direction,
a second content is displayed using the red region at a second perspective located in a direction in which the green region and the blue region overlap each other, and
a third content is displayed using the green region at a third perspective located in a direction in which the red region and the blue region overlap each other.

10. The display medium according to claim 9,
wherein each of the blue region of the first cell, the red region of the second cell, and the green region of the second cell includes a plurality of pixels, and
in the plurality of pixels of each of the regions, pixels corresponding in number to each value of red, green, and blue of colors displayed in the first cell and the second cell are colored with red, green, or blue, respectively, and the other pixels are colored with a color other than red, green, and blue.

11. The display medium according to claim 9,
wherein a minority color vision carrier with a middle wave sensitive cone dysfunction or a long wave sensitive cone dysfunction is capable of viewing a composition of a content by changing a perspective and repeatedly viewing the second content and the third content.

12. A processing device allocating a color to each pixel of the first cell and the cells of the second layer of the display medium according to claim 9,
each of the blue region of the first cell, the red region of the second cell, and the green region of the second cell including a plurality of pixels,
the processing device comprising:
a calculation unit calculating each value of red, green, and blue of colors displayed in the first cell and the second cell in the first content; and
an allocation unit allocating red, green, or blue to pixels corresponding in number to each of the calculated values of red, green, and blue, and allocating a color other than red, green, and blue to the other pixels, in the plurality of pixels of each of the regions.

13. The processing device according to claim 12,
wherein the allocation unit
allocates blue to pixels corresponding in number to the calculated value of blue, and allocates a color other than blue, red, and green to the other pixels, in the plurality of pixels of the blue region,
allocates red to pixels corresponding in number to the calculated value of red, and allocates a color other than blue, red, and green to the other pixels, in the plurality of pixels of the red region, and
allocates green to pixels corresponding in number to the calculated value of green, and allocates a color other than blue, red, and green to the other pixels, in the plurality of pixels of the green region.

14. The processing device according to claim 13,
wherein the number of pixels corresponding to the value of red is a value in a step corresponding to the value of red when a value range available to the value of red is divided into steps by the number of pixels of the red region +1.

15. A program for causing a computer to function as the processing device according to claim 12.

16. A computer-readable recording medium recording a program for causing a computer to function as the processing device according to claim 12.
